(19) United States
(12) Patent Application Publication
(10) Pub. No.: US 2012/0000433 A1
(43) Pub. Date: Jan. 5, 2012

(54) INSERT FOR A GATED CHUTE FOR SMALLER LIVESTOCK

(76) Inventor: Tommie Carroll Gipson, Eaton, CO (US)

(21) Appl. No.: 13/167,270

(22) Filed: Jun. 23, 2011

Related U.S. Application Data
(60) Provisional application No. 61/398,957, filed on Jul. 2, 2010.

(51) Int. Cl. A01K 29/00; B65G 11/00

(52) U.S. Cl. 119/843

(57) ABSTRACT

A livestock chute insert that adapts a livestock chute for use with smaller livestock. One embodiment of the insert reversibly modifies existing gated livestock chutes to prevent smaller livestock from turning around in the chute or jumping up and hurting themselves.

### CROSS-REFERENCE TO RELATED APPLICATION

The present application, pursuant to 35 U.S.C. 111(b), claims the benefit of the earlier filing date of provisional application Ser. No. 61/398,957 filed Jul. 2, 2010, and entitled “Gated Chute Adapted for Smaller Livestock”

### BACKGROUND OF THE INVENTION

1. Field of the Invention

The present invention relates to an adaptive device for a livestock chute to adapt the chute for smaller livestock. In particular, the present invention relates to an insert for a livestock chute for reversibly modifying existing gated chutes to prevent smaller livestock from turning around in the chute or jumping up and hurting themselves.

2. Description of the Related Art

Rodeo contests have become popular in recent years, particularly in the western states of the United States, and many cowboys and other western riders have become highly skilled in the performance of certain cattle handling feats, such as bulldogging, steer-roping, and calf-roping. Roping, for example, is increasingly popular as a family sport and today there are more than 100,000 members in the United States Team Roping Association. Ropers often exhibit their skills in competitions where they actively compete with each other for prize money before large audiences during rodeo performances.

Generally these events requires that a steer or a calf be brought into a holding chute having a gate which can be selectably opened and closed for the entrance, retention, and release of the animal. Holding chutes provided with entry and exit gates are also traditionally used by rodeo performers to temporarily hold and release cattle for mounted roping practice.

Furthermore, holding chutes are used to hold individual livestock for annual vaccinations, parasite treatment, weighing, and other processes.

Unfortunately, smaller livestock such as a calf, sheep, pig and the like will sometimes hurt themselves by jumping up and/or turning around within the chute. A need exists for a selectably removable insert for livestock chutes that will limit the movement of smaller livestock and prevent them from hurting themselves.

### SUMMARY OF THE INVENTION

The present invention relates to a selectably removable insert for livestock chutes that will limit the movement of smaller livestock and prevent them from hurting themselves.

One embodiment of the present invention is an insert for a livestock chute comprising: (a) an insert base frame that is insertable into a livestock chute, the insert base frame having a first side wall, an opposed second side wall, an entry passage on a first end of the base frame, and an exit passage on a second end of the base frame, wherein the entry passage and the exit passage are substantially equal in size and shape; and (b) a plurality of top bars, wherein each top bar comprises a first bar end curved in a first direction from a central portion of the top bar and a second bar end curved in the first direction and where each top bar is attached to the insert base frame so that the first bar end is mounted to a top end of the first side wall, the second bar end is mounted to a top end of the second side wall.

A second embodiment of the present invention is an insert for a livestock chute comprising: (a) a first side wall having a first upper section, a first lower section, and a first interconnecting section that joins a second end of the first upper section and a first end of the first lower section; (b) a second side wall having a second upper section, a second lower section, and a second interconnecting section that joins a second end of the second upper section and a first end of the second lower section; and (c) a plurality of crossbars wherein each crossbar comprises a first bar end curved in a first direction from a central portion of the crossbar and a second bar end curved in the first direction and where the first bar end is mounted on a first end of the first upper section and the second bar end is mounted on a first end of the second upper section.

A third embodiment of the present invention is an insert for a livestock chute comprising: (a) a first side wall having a first upper section, a first lower section, and a first interconnecting section that joins a second end of the first upper section and a first end of the first lower section; (b) a second side wall having a second upper section, a second lower section, and a second interconnecting section that joins a second end of the second upper section and a first end of the second lower section, wherein the second upper section is substantially parallel with the first upper section and the second lower section is substantially parallel with the first lower section; and (c) a plurality of crossbars wherein each crossbar comprises a first bar end curved in a first direction from a central portion of the crossbar and a second bar end curved in the first direction and where the first bar end is mounted on a first end of the first upper section and the second bar end is mounted on a first end of the second upper section.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows an end view of one embodiment of a chute insert.

FIG. 2 shows an oblique view of the chute insert of FIG. 1.

FIG. 3 illustrates another embodiment of a chute insert where the insert is modified by mounting end guards to the entrance and exit of the chute insert.

FIG. 4 shows an oblique view of a pair of mirror image lower guides which may be used as end guards and optionally mounted on the chute insert of FIG. 1.

FIG. 5 shows an oblique view of a pair of opposed upper guides which may be mounted on the chute insert in conjunction with the lower guides shown in FIG. 4.

FIG. 6 is an oblique view of a conventional roping chute, shown with one of its end gates open.

FIG. 7 is a plan view of a conventional roping chute, shown with the chute insert of FIG. 1 modified by the addition of the end guards shown in FIGS. 4 and 5.

FIG. 8 is an end view of a conventional roping chute shown with the modified roping chute insert of FIG. 3 inserted therein. In this view, both end gates of the roping chute are open.

FIG. 9 is an oblique view of a remotely operable roping chute shown with the entry gate and the no return barrier open to admit an animal. The roping chute insert is not installed in this view.

FIG. 10 is a plan view corresponding to FIG. 9.

FIG. 11 is an oblique view corresponding to FIGS. 9 and 10, but showing the chute insert of FIG. 1 aligned for insertion into the roping chute.

FIG. 12 is an end view of the remotely operable roping chute of FIGS. 9, 10, and 11 showing the chute insert of FIG. 1 installed therein.

FIG. 13 is an oblique view corresponding to FIG. 12.

### DESCRIPTION OF THE PREFERRED EMBODIMENTS

Embodiments of the present invention relate to a selectably removable insert for livestock chutes that will limit the movement of smaller livestock and prevent them from hurting themselves. Livestock holding chutes are particularly useful for rodeo events, livestock management, and the like.

Standard livestock chutes typically include a rectangular basic frame with two interconnected sides to form a livestock enclosure having an entry passage and an exit passage. Livestock or roping chutes are deliberately made relatively narrow and with limited interior heights so that a cow or other livestock cannot turn around while in the chute and must exit only at the end of the chute opposite to that where it entered. A problem arises for the typical standard chute sized for large animals when smaller calves or other animals are penned and passed through. Unfortunately smaller animals weighing less than about 150 pounds are able to turn around readily, either by simply rotating about a vertical axis or by rearing and rotating. One object of the present invention is to provide an easily installed and removed means for preventing the turning around of smaller calves in a roping chute designed for larger animals.

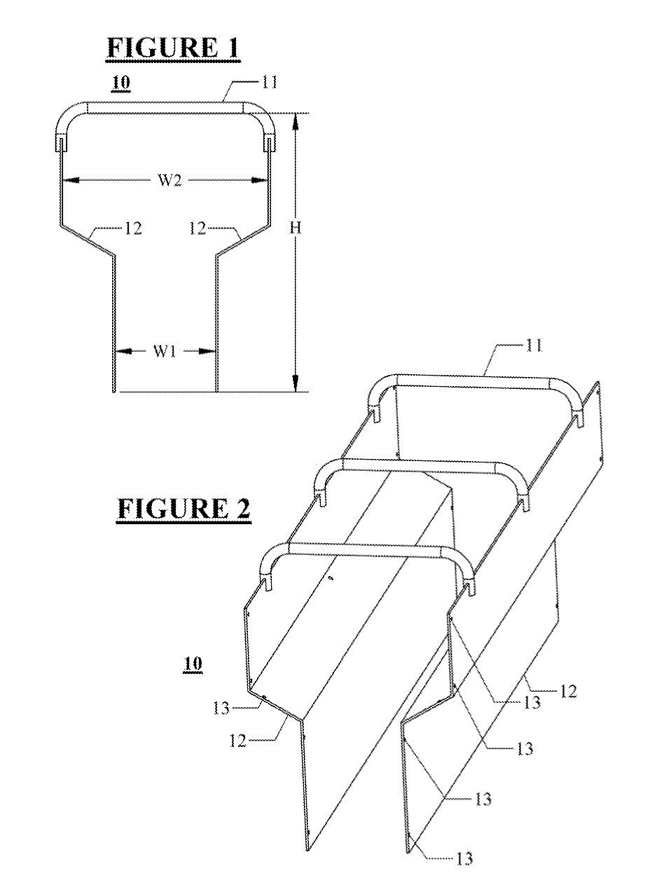

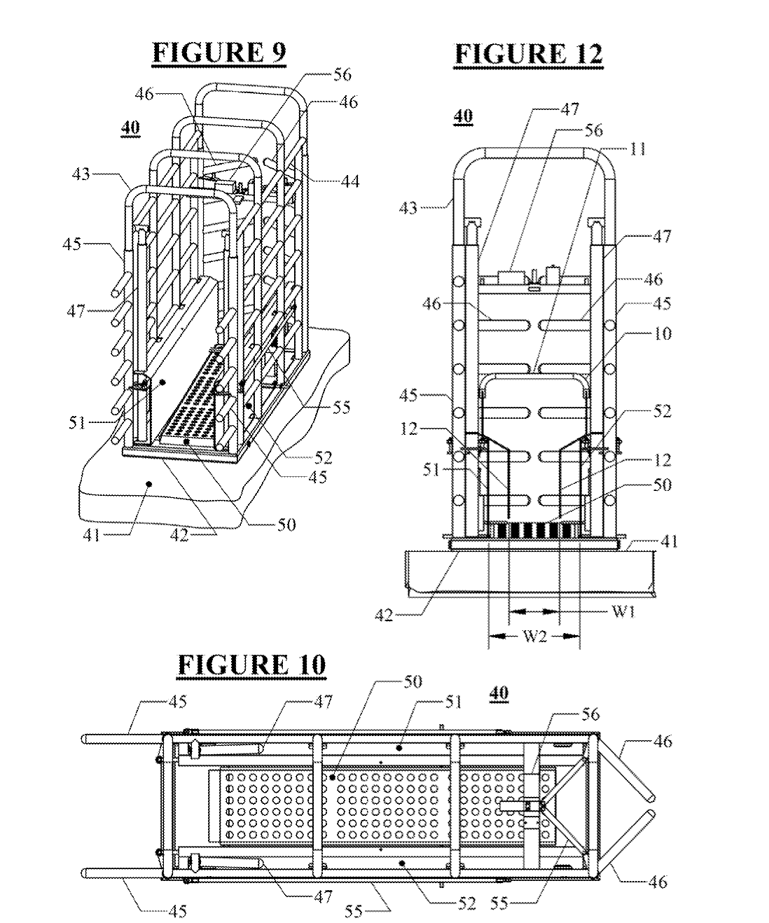

One embodiment of a livestock chute insert 10 is illustrated in FIGS. 1, 2 and 3. This embodiment of the chute insert 10 fits into any general livestock chute such as the one shown in FIG. 6 or the remotely operable chute illustrated in FIG. 9 and described in U.S. Pat. No. 7,918,191. The chute insert 10 is constructed to be quickly and easily insertable or removable by a single individual.

Although the embodiment described in detail below and shown in FIG. 1 is generally constructed of steel plates and tubes, it is recognized that any cross-sectional shape of any material which is sufficiently durable and strong can be used to construct the frame. Furthermore, the attachment of the components of the frame may be effected by welding or if desired by pipe-fitting attachment means and the like.

The chute insert 10 is made to be laterally centered between the interior sides of a roping chute 40 or 70 and is centered at approximately midlength of the main chute. The chute insert 10 consists of two spaced apart side plates 12 joined by multiple crossbars 11. Typically the two side plates will be substantially identical to each other and will be in mirror image positions joined by multiple identical equispaced crossbars 11. The U-shaped crossbars 11 are symmetrical about their transverse midplanes and have short downwardly extending vertical segments joined to the relatively long horizontal center sections by large radius bends. The lower ends of a crossbar 11 have short upwardly extending notches parallel to the transverse midplane of the crossbar. The notches are engaged with the upper edges of the side plates 12 and are generally welded at those locations to join the crossbars 11 to the side plates 12.

Each side plate 12 is made of several different sections. Each side plate of the embodiment of chute insert 10 illustrated in FIG. 1 has a vertical upper section, a lower vertical section, and an interconnecting section. The upper and lower sections of each side plate 12 are parallel, but offset. An inclined plate segment (the interconnecting section) bends upwardly and outwardly to connect the lower and upper sections of each side plate 12. When the chute insert 10 is assembled, the parallel lower sections of the opposed side plates 12 are spaced apart by a distance W1, while the parallel upper sections of the side plates are spaced apart by a distance W2. The clear inside height from the bottom of the side plates 12 to the underside of the horizontal portion of the crossbars is H, as seen in FIG. 1.

Multiple small diameter transverse through holes 13 are each spaced a short distance from each transverse end of the side plates 12. For each end of the side plates 12, two holes 13 are located in the lower vertical section and two holes 13 are located in the upper vertical section. For each end of a side plate 12, one transverse through hole is located in the interconnecting section of the side plate 12. Additionally, a hole 14 is positioned at midlength of each side plate 12 a short distance below the intersection of the upper section and the interconnecting section. The holes 14 permit selective mounting by means of bolt and nut pairs 34 of the chute insert 10 to suitable attachment points provided in the remotely operable roping chute 40 shown in FIG. 9. For example, the remotely operable roping chute 40 has a lefthand mechanism cover 51 and a righthand mechanism cover 52 that are suitable for mounting the interconnecting and lower sections of the left and right side plates 12 respectively.

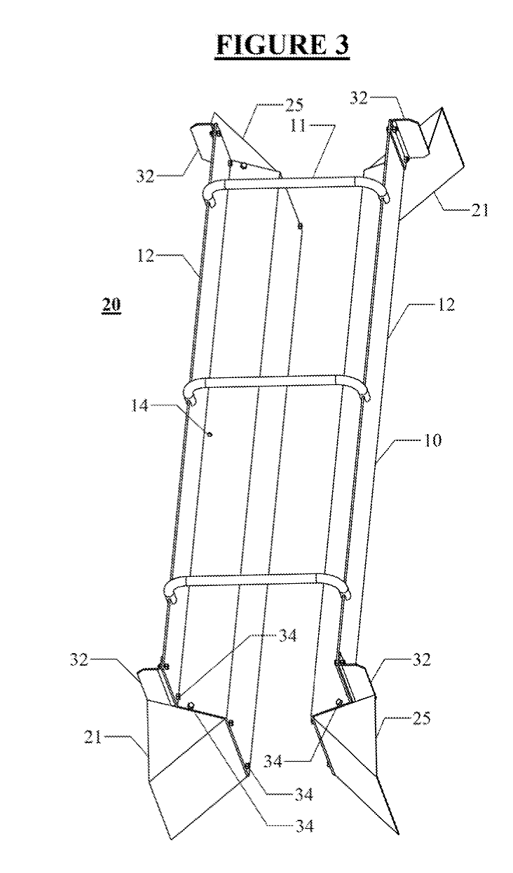

The chute insert 10 shown in FIG. 3 shows a modified version 20 of the chute insert 10. This modified version 20 is made to fit centered laterally and longitudinally within a conventional roping chute 70 as shown in FIG. 6. Since the conventional roping chute 70 does not have the side mechanism covers 51 and 52 for mounting the chute insert, the modified chute insert 20 will typically have optional side panels or edge guards attached to the lower sections of the side plates to avoid any problematic gaps or edges.

The embodiment of the modified chute insert 20 has two each of lefthand lower guides 21 and righthand lower guides 25, as well as four upper guides 16 attached to the chute insert 10. The two ends of the modified chute insert 20 are configured similarly. The upper 16 and lower guides 21, 25 are selectably mounted by means of bolt and nut pairs 34 to the mounting holes 13 of the side plates 12.

The lefthand 21 and righthand 25 lower guides are basically mirror images of each other. The lefthand guide 21 consists of one or two rectangular vertical sections 22 cojoined by an inclined triangular section 23. One vertical edge of the lefthand lower guide 21 mounts two horizontally extending rectangular mounting tabs 24, and the adjacent inclined edge mounts a third mounting tab 24. Each mounting tab 24 has a centrally located through hole. The mounting tabs 24 for the vertical section of lefthand lower guide 21 are at an angle with the vertical side 22 and extend horizontally with the same spacing as the accessory mounting holes 13 in the lower section of the side plate 12 on the left side when the roping chute insert 10 is viewed looking inwardly at one end.

The mounting tab 24 on the upper triangular section of the lefthand lower guide 21 is bent so that its lateral edges are horizontal and parallel to the vertical section of the guide 21. The location of the mounting tab 24 on the upper triangular section of the guide 21 is such that its hole is coaxial with the accessory attachment hole 13 on the interconnecting section of the lefthand side plate 12 when assembled with a bolt and nut pair 34 to the chute insert 10.

Referring to FIGS. 3 and 4, the vertical section 22 of the installed lefthand lower guide 21 is outwardly inclined relative to the lower vertical section of its mounting side plate 12. The tabbed edge of the inclined section 23 of lefthand lower guide 21 is coplanar with the interconnecting section of the side plate 12 to which it is attached. The righthand lower guide 25 is basically the mirror image of lefthand lower guide 21, with its vertical section 26, its inclined section 27, and its mounting tabs 28 corresponding to vertical section 22, inclined section 23, and mounting tabs 24, respectively.

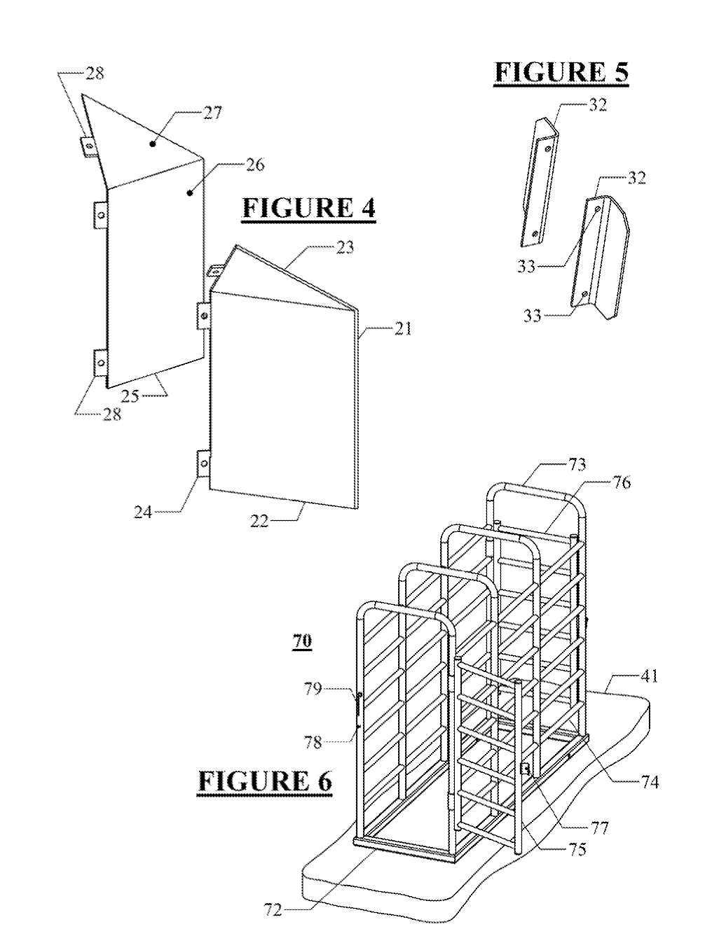

The upper guides 32, seen in FIGS. 3 and 5, are short unequal leg angle sections symmetrical about their transverse midplanes. The short leg of an upper guide 32 has symmetrically placed transverse through mounting holes 33 which can be aligned with the two side plate 12 mounting holes 13 on either end of an upper vertical section of the side plate. When mounted to the exterior of the side plates 12 using bolt and nut pairs 34, the long legs of the upper guides 32 extend transversely outwardly to the side of their side plates and abut the tabbed edge of the inclined section 23 or 27 of a lower guide plate 21 or 25, respectively.

These relationships can best be understood from inspection of FIG. 3. The lower guides 21 and 25 thus form a tapered entry and exit to the modified chute insert 20. The upper guides 32 present an outwardly extending transverse surface at the entry and exit of the modified chute insert 20.

Referring to FIGS. 9, 10 and 11, the remotely operable roping chute 40 described in U.S. Pat. No. 7,918,191 can be seen respectively in an oblique end view, a plan view, and an oblique end view with the chute insert 10 axially aligned for insertion into the roping chute 40. The remotely operable roping chute 40 has a rectangular tubing elongated rectangular perimeter base frame 42 which rests on a flat ground surface 41. The inside width of the rectangular base frame 42 is somewhat larger than the width of a full grown bovine.

On its upper side, the rectangular base frame 42 mounts vertically extending transverse U-shaped arched tubular crossbars 43. The parallel legs of the crossbars 43 extend downwardly from the central upper horizontal section where they are welded to the base frame 42. These four vertically extending crossbars 43 are parallel to the short transverse sides of the base frame 42 and equispaced along the length of the base frame 42. One crossbar 43 is located at each end of the base frame 42.

An entry gate half 45 consists of a vertical tube having multiple vertical equispaced coplanar horizontal tubular stubs attached one side. The vertical tube of an entry gate half 45 is larger than the vertical leg of an arcuate crossbar 43. An antisymmetric pair of entry gate halves 45 are pivotably mounted on opposite sides of the arcuate crossbar 43 at the entry end of the roping chute 40. The exit gate halves 46 are identical to the entry gate halves 45 and are pivotably mounted antisymmetrically on the opposite sides of the arcuate crossbar 43 at the exit end of the roping chute 40.

The two nonreturn gate halves 47 are structurally similar to the entry 45 and exit 46 gate halves, but have only a single horizontal tubular stub at midlength. A nonreturn gate half 47 is antisymmetrically pivotably mounted concentric with each vertical tube 58. The nonreturn gate halves 47 are spring biased to close and to let an animal pass into the roping chute 40, but are prevented by travel stops from opening to let an animal exit through the entry end of the roping chute 40. The entry 45 and exit gate 46 halves are operated by a complex operative linkage mechanism 55 which is controlled by a radio receiver and control 56.

A perforated planar floor treadle 50 is pivotably mounted to the base frame 42 horizontally and transversely at the entry end of the roping chute 40. The floor treadle 50 extends most of the length of the roping chute 40. The normal position of the floor treadle 50 is to have its unpivoted end upwardly positioned. When the floor treadle 50 is depressed by the weight of a bovine, it pivots downwardly to abut the ground surface 41 while causing the entry gate halves 45 to close. When a radio signal is issued by a handheld transmitter, the radio receiver and control 56 releases a detented, spring loaded member in the operative linkage 55 to open the exit gate 46 halves.

The operative linkage 55 is complex and interconnects the floor treadle 50, the entry gate halves 45, and the exit gate halves 46. Part of the linkage 55 is located on the interior side of the roping chute 40, where it is protected by lefthand 51 and righthand 52 cover plates. The cover plates 51 and 52 are mirror images. Each cover plate 51, 52 has a long vertically extending planar rectangular segment joined by a shorter inclined rectangular horizontal segment. The angle between the vertical and inclined segments is approximately 60°. The angle is the same as that of between the vertical and inclined portions of the side plates 12 of the basic roping chute insert 10.

The cover plates 51 and 52 cover and protect the mechanism of the remotely operable roping chute 40. However, the protrusion of the cover plates 51 and 52 into the lower portion of the remotely operable roping chute 40 means that the lower portion of the roping chute 40 is not as wide as a standard roping chute 70, even though the upper portion of chute 40 has substantially the same width as a standard chute 70.

A standard roping chute 70 is shown in an oblique view in FIG. 6. A standard roping chute 70 can be set on the ground surface 41 and has a rectangular tubular base frame 72. On its upper side, the rectangular base frame 72 mounts four vertically extending transverse U-shaped arched tubular crossbars 73. The parallel legs of the crossbars 73 extend downwardly from the central upper horizontal section where they are welded to the base frame 72. These four vertically extending crossbars 73 are parallel to the short transverse sides of the base frame 72 and equispaced along the length of the base frame 72. One crossbar 43 is located at each end of the base frame 72.

On each side of the roping chute 70 multiple vertically equispaced tubular horizontal bars 74 having coped ends are welded between adjacent arched tubular crossbars 73 of the rectangular base frame 72 of the conventional roping chute 70. These vertical 73 and horizontal 74 bars are sized to withstand forces applied by a penned animal and to keep the animal from escaping laterally or out the top of the chute.

Identical entry 75 and exit 76 gates consist of two tubular verticals cojoined by multiple equispaced smaller horizontal tubes which are coped and welded to the vertical tubes. Two other short tubes having inner diameters which are slip fits to the exterior of the tubular crossbars 73 are coaxially attached to one vertical tube of a gate 75 or 76 so that their centerlines are coplanar with the horizontals of those gates. The short tubes are equispaced from the upper and lower ends of the gates 75, 76 and are respectively mounted concentrically and pivotably on one leg of the entry and exit end arcuate crossbars 73 at the entry and exit ends of the of the roping chute 70. As illustrated in FIGS. 6 and 8, the width W3 of the modified chute insert 20 is approximately the same at the top section of the standard chute 70 proximal the crossbars 73 and at the bottom section of the chute 70 proximal the rectangular base frame 72.

Each gate 75, 76 has a short half round tubular segment latch plate 77 welded at midheight of the gate so that its centerline is vertical and coplanar with the gate. A small centrally positioned rectangular through hole penetrates the latch plate perpendicular to the plane of the gate. A small horizontal U-shaped loop latch pin holder 78 is welded to the vertical leg opposed to the gate pivot leg of each end crossbar 73 at a height and position so that when the gate 75 or 76 is fully closed, the loop 78 passes through the hole in the latch plate 77 of the gate. The outward extension of the latch pin holder 78 is sufficient to permit the insertion of a latch pin 79 to keep the gate closed.

The latch pin 79 is a elongated rod having either a loop bent at its upper end as shown herein or a right angle bend. The loop or bend prevents the pin falling vertically out of engagement with the latch pin holder 78. Insertion of the latch pin 79 can be used to maintain selectable closure of a gate 75 or 76.

### Operation of the Invention

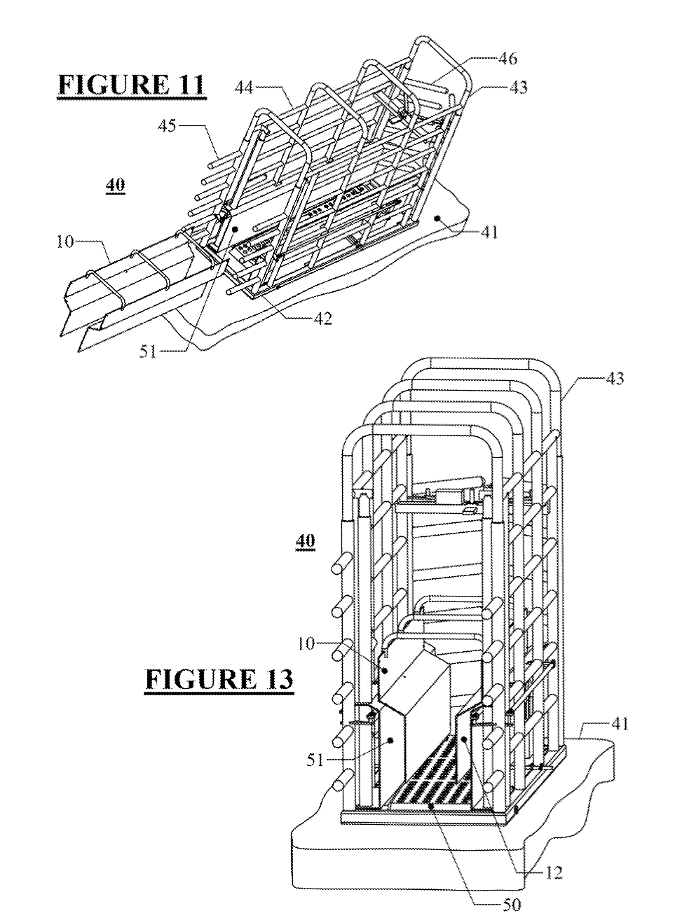

FIG. 11 shows the remotely operated roping chute 40 ready for insertion of the chute insert 10. FIGS. 12 and 13 show the basic roping chute insert 10 installed in the chute 40. Referring particularly to FIG. 12, it can be seen that the nonreturn gate halves 47 and the cover plates 51 and 52 narrow the lower portion of the path through the roping chute 40. The placement of the chute insert 10 into the roping chute 40 only slightly narrows the lower portion of the path through the chute 40. Accordingly, the optional lefthand 21 and righthand 25 lower guides and the upper guides 32 are probably not required to avoid abrading the legs of any entering and exiting calves or other small livestock.

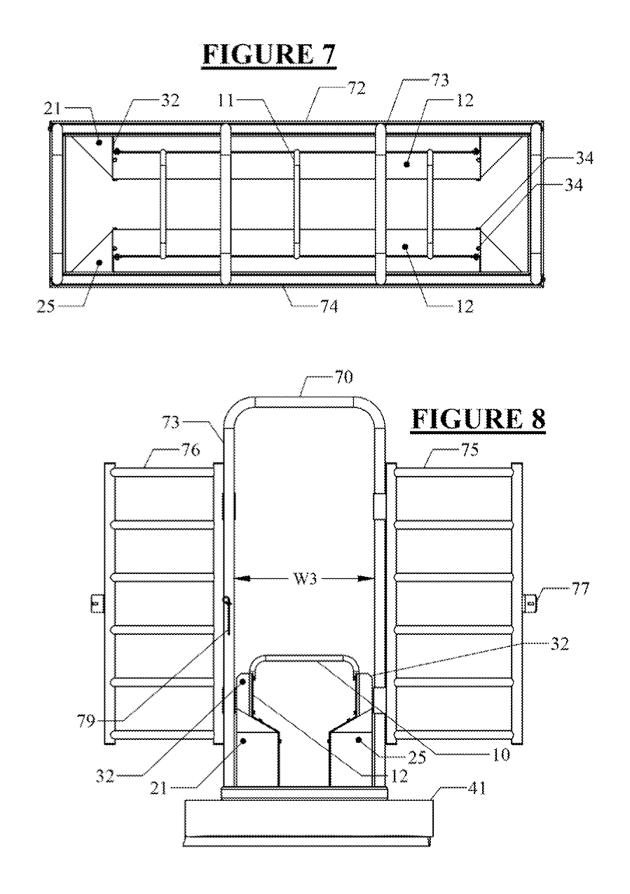

FIGS. 7 and 8 show the modified chute insert 20 installed in a standard roping chute 70. Because the lower portion of the interior passage of the standard roping chute 70 is generally wider than the lower portion of the passage of the remotely operated roping chute 40, a fairly large gap can exist between the chute insert 10 and the inner passage of the chute.

To prevent the calves or other small livestock from possible injury by contact with the vertical transverse edges of the chute insert 10 or entanglement within any potential gap between the chute insert 10 and the roping chute 70, the chute insert 10 will preferably be modified to add edge guards to the front and back ends of the chute insert 10. One embodiment of such edge guards is shown in FIGS. 3 and 4 and described in detail above. The optional lefthand 21 and righthand 25 lower guides and the upper guides 32 represent just one of many workable edge guard designs.

FIGS. 7 and 8 show the modified chute insert 20 placed within a standard roping chute 70. The placement of the modified chute insert 20, with its transversely outwardly extending lefthand 21 and righthand 25 lower guides and upper guides 32, within the standard roping chute 70 avoids any problematic gaps and edges which could injure smaller livestock.

### Advantages of the Invention

The roping chute insert of the present invention permits a roping chute to readily be converted from use with full size cattle to use with small calves. Because of its light weight, the chute insert 10 or the modified chute insert 20 is readily installed and removed by one or two men. Thus, the use of the chute insert 10 or the modified chute insert 20 permits a roper to utilize only a single roping chute for all sizes of cattle.

The specific dimensions and shape of the chute insert or the end edge guards may be modified without departing from the concept of a readily installed chute insert to adapt a standard roping chute for smaller livestock.

What is claimed is:

1. A livestock chute insert comprising:
a. an insert base frame that is insertable into a livestock chute, the insert base frame having a first side wall, an opposed second side wall, an entry passage on a first end of the base frame, and an exit passage on a second end of the base frame, wherein the entry passage and the exit passage are substantially equal in size and shape; and
b. a plurality of top bars, wherein each top bar comprises a first bar end curved in a first direction from a central portion of the top bar and a second bar end curved in the first direction and where each top bar is attached to the insert base frame so that the first bar end is mounted to a top end of the first side wall, the second bar end is mounted to a top end of the second side wall.

2. The livestock chute insert of claim 1, wherein the first side wall has a first upper section, a first lower section, and a first interconnecting section that joins a second end of the first upper section and a first end of the first lower section; and wherein the second side wall has a second upper section, a second lower section, and a second interconnecting section that joins a second end of the second upper section and a first end of the second lower section.

3. The livestock chute insert of claim 2, wherein the second upper section is substantially parallel with the first upper section and the second lower section is substantially parallel with the first lower section.

4. The livestock chute insert of claim 3, wherein the distance between the second upper section and the first upper section is greater than the distance between the second lower section and the first lower section.

5. The livestock chute insert of claim 1, wherein the entry gate and the exit gate have opposed righthand and lefthand edge guards attached to the opposed side walls of the base frame.

6. The livestock chute insert of claim 1, wherein the chute insert is attached to an interior surface of a livestock chute.

7. A livestock chute insert comprising:
a. a first side wall having a first upper section, a first lower section, and a first interconnecting section that joins a second end of the first upper section and a first end of the first lower section;
b. a second side wall having a second upper section, a second lower section, and a second interconnecting section that joins a second end of the second upper section and a first end of the second lower section; and
c. a plurality of crossbars wherein each crossbar comprises a first bar end curved in a first direction from a central portion of the crossbar and a second bar end curved in the first direction and where the first bar end is mounted on a first end of the first upper section and the second bar end is mounted on a first end of the second upper section.

8. The livestock chute insert of claim 7, wherein the second upper section is substantially parallel with the first upper section and the second lower section is substantially parallel with the first lower section.

9. The livestock chute insert of claim 8, wherein the distance between the second upper section and the first upper section is greater than the distance between the second lower section and the first lower section.

10. The livestock chute insert of claim 7, wherein a first edge guard is attached to a vertical edge of the first lower section and a second edge guard is attached to a vertical edge of the second lower section.

11. The livestock chute insert of claim 7, wherein a first edge guard is attached to a first vertical edge of the first lower section and a second edge guard is attached to a first vertical edge of the second lower section and a second edge guard is attached to a second vertical edge of the first lower section and a second edge guard is attached to a vertical edge of the second lower section.

12. The livestock chute insert of claim 10, wherein the first edge guard and the second edge guard are mirror images of each other.

13. The livestock chute insert of claim 7, wherein the chute insert is attached to an interior surface of a livestock chute.

14. The livestock chute insert of claim 7, wherein a height of the chute insert is less than a height of the livestock chute.

15. The livestock chute insert of claim 7, wherein the first side wall is a mirror image of the second side wall.

16. A livestock chute insert comprising:
a. a first side wall having a first upper section, a first lower section, and a first interconnecting section that joins a second end of the first upper section and a first end of the first lower section;
b. a second side wall having a second upper section, a second lower section, and a second interconnecting section that joins a second end of the second upper section and a first end of the second lower section, wherein the second upper section is substantially parallel with the first upper section and the second lower section is substantially parallel with the first lower section; and
c. a plurality of crossbars wherein each crossbar comprises a first bar end curved in a first direction from a central portion of the crossbar and a second bar end curved in the first direction and where the first bar end is mounted on a first end of the first upper section and the second bar end is mounted on a first end of the second upper section.

17. The livestock chute insert of claim 16, wherein the distance between the second upper section and the first upper section is greater than the distance between the second lower section and the first lower section.

18. The livestock chute insert of claim 16, wherein a first edge guard is attached to a vertical edge of the first lower section and a second edge guard is attached to a vertical edge of the second lower section.

19. The livestock chute insert of claim 16, wherein a first edge guard is attached to a first vertical edge of the first lower section and a second edge guard is attached to a first vertical edge of the second lower section and a second edge guard is attached to a second vertical edge of the first lower section and a second edge guard is attached to a vertical edge of the second lower section.

20. The livestock chute insert of claim 16, wherein the first and second upper and lower sections are vertical and connected by the interconnecting section that is inclined.
